(19) United States
(12) Patent Application Publication
(10) Pub. No.: US 2026/0368968 A1
(43) Pub. Date: Nov. 19, 2026

(54) SYSTEMS AND METHODS FOR RESEARCH OUTPUT GENERATION AND SELECTION

(71) Applicant: GDM Holding LLC, Mountain View, CA (US)

(72) Inventors: Mukund Harakere Sridhar, Mountain View, CA (US); Shubham Gupta, Sunnyvale, CA (US); Siddharth Vashishtha, Jersey City, NJ (US); Aarush Selvan, New York, NY (US); Rushin Shah, Fremont, CA (US); Mohak Patel, San Francisco, CA (US); Shuli Liu, Castro Valley, CA (US); Brian Baugh, Seattle, WA (US); Geoff Barnes, Pittsburgh, PA (US); Hafeezul Rahman Mohammad, San Jose, CA (US)

(21) Appl. No.: 19/657,792

(22) Filed: Apr. 24, 2026

Related U.S. Application Data
(60) Provisional application No. 63/808,393, filed on May 19, 2025.

(51) Int. Cl. G06T 11/60; G06F 16/248; G06F 40/40

(52) U.S. Cl. CPC G06T 11/60; G06F 16/248; G06F 40/40; G06T 2200/24

(57) ABSTRACT

Implementations herein may relate to a computer-implemented process that can include generating a prompt related to a research task based on user input for processing using one or more generative models (GMs). A plurality of research sub-tasks based on the prompt using the one or more GMs can be generated. plurality of candidate elements for inclusion in a research report can be identified, and respective candidate elements can be based on the same data of the result but have a different data representation from one another. A subset of the plurality of candidate elements that are to be generated can be identified. Data can be generated based on performance of the research task using the one or more GMs. A research report can then be rendered, and the research report can include the subset of the plurality of candidate elements. Other implementations may be described and/or claimed.

### BACKGROUND

Developments in artificial intelligence and machine learning have led to the creation of powerful generative models. These models have demonstrated capabilities in processing and generating various forms of data, including text, images, audio, and even executable code. This progress has opened up new possibilities for automating complex tasks, such as information gathering, analysis, and content creation.

In the context of research and information synthesis, prior art systems often rely on keyword-based searches or predefined templates to compile information. Some legacy approaches can involve retrieving relevant documents and presenting them to a user for manual review and synthesis. Other systems can attempt to automatically extract information from sources and present it in a structured format.

However, these prior art systems can face certain limitations. For example, while automated extraction systems can improve efficiency, they can struggle with the nuances of complex data and might not always be able to present information in a manner that is most effective for a given user or task. Furthermore, legacy systems can default to presenting information in a single or limited set of formats, which might not cater to diverse user needs or the multifaceted nature of research data. Different types of information and different user preferences can necessitate different representations for optimal understanding and utilization. The inability to readily provide a variety of data representations based on the same underlying information can represent a challenge in the current technological landscape of automated research assistance.

### SUMMARY

Some implementations disclosed herein can be directed to generating a prompt related to a research task that is based on user input. Implementations can generate a plurality of research sub-tasks based on the prompt. Implementations can further identify a plurality of candidate elements for inclusion in a research report. Respective candidate elements can be based on a same data of the result, and have a different data representation from one another. Implementations can identify a subset of the plurality of candidate elements that are to be generated and cause performance of the research task to generate the data. Implementations can then render a research report that includes the subset of the plurality of candidate elements.

Implementations disclosed herein can mitigate (e.g., reduce or eliminate) various drawbacks with legacy techniques. For example, by generating multiple candidate elements with different data representations based on the same underlying data, the need for extensive post-processing by the user is reduced, which can lead to a reduction in required user computing power and a reduction in time spent on the task. As another example, by identifying a subset of candidate elements to be generated prior to performing the full research task, the overall computational load on the system can be reduced compared to generating all possible data representations. As another example, the ability to tailor the output data representations can reduce the amount of data transmitted by focusing on formats most relevant to the identified subset of candidate elements, thereby reducing bandwidth usage.

As a non-limiting example of some implementations disclosed herein, a user interested in understanding the current trends in green manufacturing might utilize a system as described. The user could initiate the process by providing a research query to an electronic device. Based on this input, the system could generate a prompt suitable for processing by one or more generative models. This prompt could lead to the generation of several research sub-tasks, potentially including defining green manufacturing objectives, identifying current trends, and detailing energy storage options. Subsequently, the system could identify a plurality of candidate elements that could be included in a final research report. These candidate elements, such as a glossary of terms, various summary charts, a textual summary, or even an interactive quiz, could all be based on the same underlying data resulting from the research task but be presented in different data representations. The system could present (e.g., render) indications of these candidate elements to the user. Based on the user's interaction (e.g., selecting, de-selecting, altering or editing, etc. specific options), a subset of the candidate elements could be identified for generation. The system could then perform the research task and its sub-tasks using one or more generative models to produce data. A research report could then be compiled and rendered to the user, incorporating the selected subset of candidate elements with their respective data representations.

As another non-limiting example of some implementations disclosed herein, consider a research task focused on analyzing financial performance data for a specific industry over several years. The underlying data, once generated from the research task, could be extensive and contain numerical values for revenue, expenses, profits, market share, and other metrics across multiple companies and time periods. Based on this same underlying data, a system could identify various candidate elements with different data representations. A first candidate element could be a textual summary highlighting key financial trends and outliers, suitable for quick reading and understanding the main points. A second candidate element could be a detailed table presenting the raw financial figures, which can be essential for users needing to perform their own calculations or in-depth analysis. A third candidate element could be a line graph visualizing the revenue growth of the top companies over the specified period, which can be particularly effective for showing trends at a glance. A fourth candidate element could be a pie chart illustrating the market share distribution within the industry for the most recent year, offering a clear visual comparison of company sizes. Selecting the textual summary might be preferred by a user needing a high-level overview for a presentation, while a financial analyst performing detailed modeling might select the detailed table. A data scientist could find the graphical representations useful for identifying patterns or anomalies. In this example, the selection of one data representation over another could be driven by the user's specific needs and how they intend to utilize the information.

In some implementations, after the data is generated, an additional candidate element can be generated based on this data using one or more generative models. This newly generated candidate element can also be included in the research report that is presented. For example, if the data includes financial figures, an additional candidate element might be a summary analysis of those figures presented in text format. As another example, this generated candidate element could also be based on a portion of the research report that is to be rendered.

In some implementations, after generating the data from the research task, the system can identify an additional candidate element that has a data representation different from those already selected for the subset. This additional element could then be included in the rendered research report alongside the originally selected subset. For example, if the initial subset included a text summary and a table, the system could identify that a graphical representation of key trends could be valuable and include it in the final report.

In some implementations, the identified subset of candidate elements can be fewer than the total number of candidate elements initially identified. This allows for a selection process where not all possible data representations are generated, focusing resources on those most relevant. For example, a user might be presented with options for a textual summary, a detailed table, a bar chart, a pie chart, and an interactive quiz based on the data. The user might only select the textual summary, the detailed table, and the bar chart, resulting in a subset of three candidate elements being generated and included in the report, rather than all five.

In some implementations, the identification of the subset of candidate elements can be based on rendering one or more indications of the plurality of candidate elements. This could involve presenting the user with a list of potential data representations that could be included in the report. For example, the system might display check-boxes next to options such as "Textual Summary," "Table of Key Data," "Line Graph," and "Interactive Quiz," allowing the user to indicate which ones they want to be generated.

In some implementations, identifying the subset of candidate elements can be based on user input related to the rendering of the indications of the candidate elements. This could include identifying a user's selection of one or more candidate elements from the presented options. For example, a user could click on check-boxes corresponding to the "Textual Summary" and "Line Graph" options, and these selected items would form the subset for generation. Alternatively, the identification of the subset could be based on a user's de-selection of at least one candidate element that was initially presented. For example, if all options were initially selected by default, the user could uncheck the box next to the "Interactive Quiz" option, and the remaining selected options would form the subset.

In some implementations, identifying the subset of candidate elements can be based on the expiration of a timer related to the rendering of the indications. For example, if the user does not make explicit selections within a predefined time limit, a default subset of candidate elements could be automatically identified for generation.

In some implementations, identifying the subset of candidate elements can include identifying user input related to a change to a candidate element of the one or more candidate elements based on the rendering of the indications. For example, a user might indicate that they want a specific type of chart, like a bar chart instead of a line graph, or suggest a different level of detail for a textual summary. This user input could influence which specific candidate element is included in the subset or how it is generated.

In some implementations, identifying the subset of candidate elements can also include rendering indications of the research sub-tasks and identifying user input related to those sub-tasks. For instance, if one of the sub-tasks is to "Identify energy storage options," and the user provides input related to this sub-task (e.g., by editing the sub-task description or adding specific resources related to batteries), this input could influence which candidate elements are identified for the subset, such as prioritizing a candidate element representing a summary of battery technologies.

In some implementations, a candidate element of the plurality of candidate elements can include a textual data representation. This means that the information derived from the research task could be presented as written text, such as a summary, an executive overview, or a detailed explanation.

In some implementations, a candidate element of the plurality of candidate elements can include a non-textual visual data representation. This could encompass various graphical or visual formats for presenting the data, such as charts (e.g., bar charts, pie charts, line graphs), diagrams, images, or other visual aids that convey information without relying solely on text.

In some implementations, a candidate element of the plurality of candidate elements can include a non-textual audio data representation. This could involve presenting information in an auditory format, such as a spoken summary of the research findings, an audio clip of key data points, or other sound-based representations of the data.

In some implementations, a candidate element of the plurality of candidate elements can include an interactive data representation. This type of representation allows for user interaction with the data, such as an interactive quiz to test understanding of the material, a dynamic chart that allows users to explore different data points, or a simulator that allows users to manipulate variables and see the results.

In some implementations, the data representation of a candidate element can be identified based on an attribute of the user. For example, if the user is identified as having a background that benefits from visual learning, more non-textual visual data representations might be prioritized for inclusion as candidate elements. As another example, a user's role (e.g., executive vs. technical analyst) could influence whether high-level textual summaries or detailed tables are suggested.

In some implementations, the data representation of a candidate element can be identified based on a characteristic of the research task itself. For example, if the research task involves analyzing financial data, candidate elements with table or graph data representations might be prioritized. If the research task is focused on definitions and concepts, a candidate element with a glossary data representation might be more relevant.

### BRIEF DESCRIPTION OF THE DRAWINGS

FIG. 1 schematically depicts an example environment in which selected aspects of the present disclosure may be implemented, in accordance with various implementations.

FIG. 2 depicts an example of a user interface, in accordance with various implementations.

FIG. 3 depicts an alternative example of a user interface, in accordance with various implementations.

FIG. 4 depicts an alternative example of a user interface, in accordance with various implementations.

FIG. 5 depicts an alternative example of a user interface, in accordance with various implementations.

FIG. 6 depicts an example of a research report, in accordance with various implementations.

FIG. 7 depicts an example process, in accordance with various implementations.

FIG. 8 schematically depicts an example architecture of a computer system, in accordance with various implementations.

### DETAILED DESCRIPTION

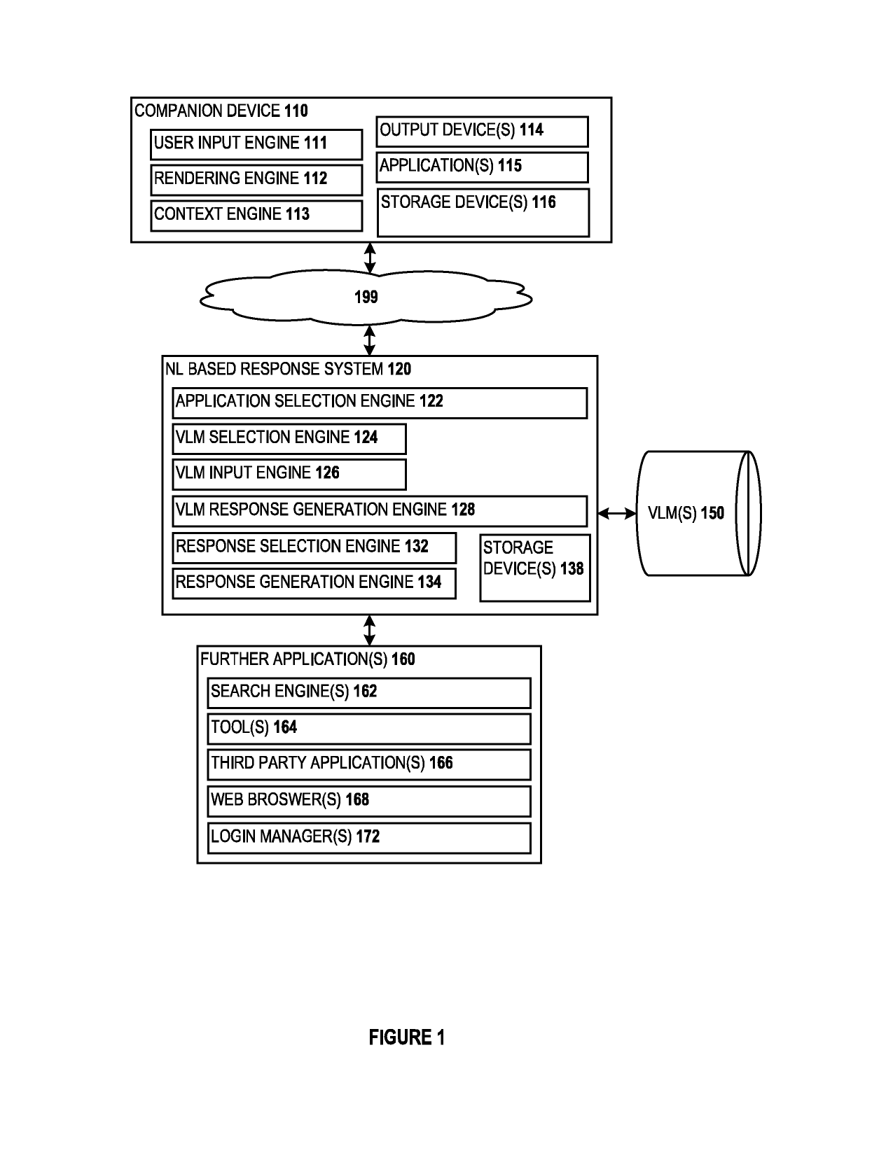

Turning now to FIG. 1, a block diagram of an example environment that demonstrates various aspects of the present disclosure, and in which implementations disclosed herein can be implemented, is depicted. The example environment can include a companion device 110, a natural language (NL) response system 120, and one or more further applications 160 (e.g., applications external to a VLM or a dialogue application executed on the companion device 110).

Although illustrated as separate elements in FIG. 1, in some implementations, all or aspects of the NL based response system 120 and/or all or aspects of the one or more further applications 160 can be implemented as part of a cohesive system. In some implementations, all or aspects of the NL based response system 120 and/or the further applications 160 can be implemented locally at the companion device 110 (e.g., as part of a single physical unit such as a single cellular telephone, personal digital assistant (PDA), tablet device, laptop, desktop computer, etc.). In additional or alternative implementations, all or aspects of the NL based response system 120 and/or one or more electronic devices that implement or include the further applications 160 can be implemented remotely from the companion device 110 as depicted in FIG. 1 (e.g., at one or more remote server(s)). In those implementations, the companion device 110 and the NL based response system 120 and/or the electronic device(s) that implement the further application(s) 160 can be communicatively coupled with each other via one or more networks 199, such as one or more wired or wireless local area networks (“LANs,” including Wi-Fi LANs, mesh networks, Bluetooth, near-field communication, etc.) or wide area networks (“WANs”, including the Internet, one or more cellular networks, one or more satellite-based networks, etc.).

The companion device 110 can be, for example, one or more of: a desktop computer, a laptop computer, a tablet, a mobile phone, a PDA, a computing device of a vehicle (e.g., an in-vehicle communications system, an in-vehicle entertainment system, an in-vehicle navigation system), a standalone interactive speaker having a display, a smart appliance such as a smart television or smart refrigerator, and/or a wearable apparatus of the user that includes a computing device (e.g., a watch of the user having a computing device, glasses of the user having a computing device, a virtual or augmented reality computing device, etc.). Additional and/or alternative companion devices can be provided.

The companion device 110 can execute one or more applications, such as application(s) 115, via which user input related to a research task can be submitted and/or research results can be rendered (e.g., audibly and/or visually). The application(s) 115 can be an application that is separate from an operating system of the companion device 110 (e.g., one installed “on top” of the operating system) – or can alternatively be implemented directly by the operating system of the companion device 110. For example, the application(s) 115 can be a web browser installed on top of the operating system (OS), or can be an application that is integrated as part of the operating system functionality. The application(s) 115 can interact with the NL based response system 120.

In various implementations, the companion device 110 can include a user input engine 111 that is configured to detect user input provided by a user of the companion device 110 using one or more user interface input devices. For example, the companion device 110 can be equipped with one or more microphones that capture audio data, such as audio data corresponding to spoken utterances of the user or other sounds in an environment of the companion device 110. Additionally, or alternatively, the companion device 110 can be equipped with one or more vision components that are configured to capture vision data corresponding to images and/or movements (e.g., gestures) detected in a field of view of one or more of the vision components. Additionally, or alternatively, the companion device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the companion device 110.

In various implementations, the companion device 110 can include a rendering engine 112 that is configured to provide content (e.g., research results generated based on a research task) for audible and/or visual presentation to a user of the companion device 110 using one or more output devices 114. For example, the output device(s) 114 can be or include one or more speakers that enable content to be provided for audible presentation to the user via the companion device 110. Additionally or alternatively, the output device(s) 114 can be or include one or more monitors or screens on which one or more visual elements can be displayed. Additionally or alternatively, the output device(s) 114 can be or include an alternative type of output device such as a haptic feedback device. Generally, the rendering engine 112 can be configured to receive digital content and facilitate changing the digital content to a user-recognizable format (e.g., sound, one or more visual elements, etc.)

In various implementations, the companion device 110 can include a context engine 113 that is configured to determine a context (e.g., current or recent context) of the companion device 110 and/or of a user of the companion device 110. In some of those implementations, the context engine 113 can determine a context utilizing current or recent interaction(s) via the companion device 110 (e.g., recent input received from, and/or output provided to, a user of the companion device 110), a location of the companion device 110, profile data of a profile of a user of the companion device 110 (e.g., an active user when multiple profiles are associated with the companion device 110), and/or other data accessible to the context engine 113.

As an example, the context engine 113 can determine a current context based on which application is active in the foreground of the companion device 110, a current or recent state of the active application, and/or content currently or recently rendered by the active application. A context determined by the context engine 113 can be utilized, for example, in supplementing or rewriting a prompt that is formulated based on user input, in generating an implied prompt (e.g., a prompt formulated independent of user input), and/or in determining to submit an implied prompt. In some implementations, a context can be based on one or more previous user interactions with the companion device 110 and/or the NL based response system 120 that were related to a same or similar topic.

The companion device 110 can additionally include one or more storage devices 116. In various implementations, the storage device(s) 116 can be implemented as memory such as non-volatile memory (NVM) like flash memory, a hard disk drive (HDD), read-only memory (ROM), etc. In some implementations, the storage device(s) 116 can be additionally or alternatively implemented as volatile memory such as cache memory, random access memory (RAM), etc. The storage device(s) can, in some implementations, store data and/or one or more software applications (e.g., application(s) 115).

Although not explicitly shown, in some implementations the companion device 110 and/or the NL based response system 120 can include one or more processors for accessing data and executing the software applications (e.g., application(s) 115), and/or other components that facilitate communication over one or more of the networks 199. In some implementations, one or more of the software applications can be installed locally at the companion device 110, whereas in other implementations one or more of the software applications can be hosted remotely (e.g., by one or more servers) and can be accessible by the companion device 110 over one or more of the networks 199.

Although aspects of FIG. 1 are illustrated or described with respect to a single companion device having a single user, it should be understood that such description is for the sake of example and is not meant to be limiting. For example, one or more additional companion devices of a user and/or of additional user(s) can also implement the techniques described herein. For instance, the companion device 110, the one or more additional companion devices, and/or any other computing devices of a user can form an ecosystem of devices that can employ techniques described herein. These additional companion devices and/or computing devices can be in communication with the companion device 110 (e.g., over the network(s) 199). As another example, a given companion device can be utilized by multiple users in a shared setting (e.g., a group of users, a household).

The example NL based response system is illustrated as including an application selection engine 122, a VLM selection engine 124, a VLM input engine 126, a VLM response generation engine 128, a response selection engine 132, a response generation engine 134, and one or more storage devices 138. It will be understood that, in various implementations, various of the engines and/or components can be omitted, combined, or otherwise altered from the configuration depicted. For example, in some implementations, one or more of the engines of the NL based response system 120 can be distributed across one or more computing systems (which might or might not include the companion device 110).

In general, NL based response system 120 can be configured to receive natural language input (or data related to the natural language input such as a machine-readable indication of such input) and context generated by the companion device 110 (e.g., by the context engine 113), and to generate a prompt based on the natural language input, the context, and/or one or more additional or alternative elements or factors as described below. The NL based response system 120 can then process the prompt to generate a response to the user's input. As is further described in the following, in some implementations such processing can be recursive such that processing of one or more prompts can lead to the generation of one or more additional prompts, which can then be subsequently processed. Such recursiveness could be cause by a variety of example factors such as user changes to the resource(s), user changes to the research task and/or one or more of the research sub-tasks, data produced by at least partially processing the prompt, etc.

In some implementations, VLM input engine 126 can, in response to receiving the user input, generate VLM input (i.e., a prompt) that is to be processed using one or more VLMs. In various implementations, the prompt can be based on a variety of factors or elements. For example, in some implementations, the prompt can be based on the received user input. Additionally or alternatively, the prompt can be based on the context provided by context engine 113. Additionally or alternatively, the prompt can be based on at least partial processing of one or more previous prompts. For example, the VLM input engine 126 could be configured to generate a prompt based on, or otherwise related to, one or more research sub-tasks that were previously generated based on a previous prompt.

In some implementations, the prompt can be based on one or more identified resources, and/or content thereof. In some implementations, such resources can be or include, for example, user-input resources, one or more-preidentified resources, and/or dynamically identified information resources. The dynamically-identified resources can be based on, for example, a topic of the user's input, and the system can be enabled (e.g., through a research sub-task or some other mechanism) to search for additional resources based on the topic. Such resource could take the form of, for example, searching the internet, searching through one or more local or remote databases, etc.. Such resources can be or include, for example, webpages, social media, academic articles, caselaw, video content, and/or some other type or style of content.

In some implementations, the resources can additionally or alternatively include resources such as files on the user’s computer, or on a computer (e.g., another workstation or a server) of the user’s and/or the user’s organization. In some implementations, the resources could be stored remotely (e.g., in a cloud drive or some other remote storage location). In these implementations, the user might (either at the time of processing the prompt or prior to provision of the user’s input) provide one or more indications of one or more locations of the user’s computer and/or other computers of the network where the system can search for resources. For example, the user may configure specific computers, specific directories, etc. in which the system can acquire resources for use in generating or processing the prompt. In these implementations, the system might be programmed to refrain from searching other locations of the user’s computer and/or the remote or local computer’s of the user’s network or organization.

In some implementations, the prompt could be based on additional user input such as selection or de-selection of one or more candidate resources, addition or replacement of a user-provided resource, selection or de-selection of one or more presented research sub-tasks, editing of a resource and/or research sub-task, editing of the prompt, etc.

In some implementations, as described elsewhere herein, the prompt might relate to a research task provided by the user. In other words, the user might provide, for example via the user input engine 111, natural language input that is related to a research topic. Based on this prompt, the NL based response system 120 can perform one or more actions as described herein such as identifying one or more research sub-tasks, identifying one or more GMs to be used in the performance of one or more of the sub-tasks, generating a new prompt based on user feedback or data that results from performance of at least one of the sub-tasks, identifying one or more resources that are to be used or excluded from use for performance of the research task (and/or sub-tasks), generating one or more sub-tasks related to generating and/or rendering an element in a given data representation, identifying a data representation with which to render or present the data, and/or performing the one or more sub-tasks to generate a data.

In some implementations, the prompt can be based on an attribute of the user. For example, if profile information related to the user is included in the context provided by context engine 113, then the prompt could include one or more indications of the user’s profile. For example, the prompt could include an indication that the user is an experienced electrical engineer. Based on this indication, candidate response(s) that relate to explanation of basic circuit diagrams or basic electrical engineering concepts could be avoided when generating and/or evaluating the one or more candidate responses. Similarly, if the prompt includes an indication that the user likely speaks a particular language (e.g., French) better than the user speaks English (for example, if the user’s profile indicates that the user was born and lives in France), then the candidate response(s) that are in English could be avoided, and response(s) that are in French could be prioritized.

In some implementations, the prompt could additionally or alternatively be based on information or instructions that are to be followed by the VLM input engine 126 in generation of the prompt. The information or instructions could be pre-configured, or could be dynamically identified (e.g., by a recursive process of the NL based response system 120) based on some other factor such as one or more of the resources, user feedback, data that results from performance of one or more sub-tasks, etc.

In some implementations, the application selection engine 122 can, in processing the prompt, determine one or more further applications 160 to invoke. The application selection engine 122 can select applications that are relevant to the user's input, e.g., determine that the user's input is directed towards subject matter within the domain of one or more further applications 160, and select/invoke one or more of the further applications 160 in response. For example, if generating a response to the prompt involves utilization of a webpage (for example, as a resource or for provision to a user as a result of processing of the prompt), then the application selection engine 122 can select a web browser application as one of the one or more further applications 160 to then access the webpage. It should be understood that the specifically depicted applications of FIG. 1 are depicted for the sake of example only, and the one or more further applications 160 can include some other application that is accessible at the companion device 110 and/or the NL based response system 120.

The VLM selection engine 124 can, in response to receiving a prompt, determine which, if any, of multiple GMs (e.g., VLM(s) 150 and/or one or more other multi-modal GMs) to utilize in generating response(s) to the prompt. For example, the VLM selection engine 124 can select none, one, or multiple GMs to utilize in generating response(s) in furtherance of processing the prompt. In some implementations, the VLM selection engine 124 can optionally utilize one or more classifiers and/or rules (not illustrated).

The VLM response generation engine 128 can process the prompt using a VLM such as one of VLMs 150, to generate one or more candidate responses that are responsive to the user's input. The candidate responses can include, for example, results of performing a research task or one or more of the research sub-tasks to generate data. In some implementations, the processing of one or more of the sub-tasks and/or the generation of the one or more candidate responses could be performed by one or more GMs that are different than the GMs used to, for example, generate a prompt and/or generate the one or more sub-tasks.

For example, a relatively lightweight GM with a relatively small dataset could be used for processes that are less resource intensive such as prompt generation, sub-tasks generation, generation of content with a textual data representation based on the results of processing one or more of the sub-tasks, etc. By contrast, one or more GMs with a larger dataset could be used for more resource-intensive tasks such as processing a sub-task to generate data. Similarly, one or more different GMs, which may or may not have a larger dataset, could be used to generate non-textual content with data representations such as images, interactive elements, audio content, movies, etc.

In some implementations, the relatively lightweight GMs may be stored in storage that is local to the companion device 110 (e.g., storage device(s) 116). The larger GMs (i.e., the GM(s) with larger datasets) could be stored remotely from the companion device 110 (e.g., VLM(s) 150 and/or storage device(s) 138). In these implementations, processing using the remote GMs could be performed by one or more processors that are remote from, but communicatively coupled with, the companion device 110 (e.g., one or more processors of a remote server that is communicatively coupled with the companion device 110 via the network 199). Similarly, processing using the local GMs could be performed by the companion device 110.

In this example, the NL based response system 120 could be duplicated or divided between the remote location and the companion device 110, so that local processing using local GM(s) was possible at the companion device, and remote processing using the remote GM(s) was also possible without having to repeatedly transmit data between the local and remote locations, which could incur significant costs in terms of bandwidth and latency.

It will be understood that this description of such division of the NL based response system 120 and different GMs or storage locations is provided as one non-limiting example, and the configurations or locations of such elements could vary in other implementations.

In some implementations, the candidate responses can additionally or alternatively include the generation, presentation, or rendering of one or more elements that relate to the same or different data, and have the similar or different data representations. Generally, as used herein, the term "data representation" can refer to a modality or format in which data is presented or rendered. For example, the candidate responses can include one or more textual elements and/or one or more non-textual elements. The non-textual elements can be or include, for example, an audio element, a video element, an interactive element (e.g., a quiz or some other element with which a user can interact, which could include textual content, non-textual content, and or some combination of textual and non-textual content), some other type of visual element (e.g., a picture or a graph), and/or some other type of element as described herein.

As noted, in some implementations, one or more of the selected candidate responses could relate to or include an interactive element (i.e., an element with an interactive data representation). In other words, the data that results from processing one or more of the research-subtasks could be rendered to the user as interactive content such as a quiz, a simulator, a conversational model, etc. that relate to or include the provision of information to, and receipt of information from, the user. In these implementations, the response generation engine may generate one or more computer instructions that, when executed by an electronic device such as companion device 110, cause the generation of execution of an applet, a script, one or more additional sub-tasks for processing using a GM, etc. (e.g., via further application(s) 160).

In some implementations, the data representation with which an element is rendered can be based on a variety of factors. In various implementations, the NL based response system 120 could identify a plurality of different possible data representations. Then, a subset of the possible data representations could be identified for rendering of data to the user.

For example, the user could provide an explicit instruction in the user's input for a given data representation. Such an instruction could be, "prepare a pie chart that shows [data]." Based on this instruction, possible candidate data representations that did not relate to a visual data representation in the form of a pie chart could be removed.

In some implementations, the data representation can be selected based on a portion of the report in which a candidate element is to be rendered. For example, a textual data representation might be suggested and/or used more often for an executive summary section to convey high-level information concisely. By contrast, for a glossary section, a textual data representation formatted as a list of terms and definitions could be identified. In the body of the report, where detailed findings are presented, a combination of data representations might be selected. In another example, a textual explanation could be accompanied by a non-textual visual data representation such as a graph to illustrate trends or a table to present specific data points. An interactive data representation, such as a simulator, might be identified for a section discussing the practical implications of the research, allowing users to explore different scenarios. In the above-described implementations, such identification of the data representation could be performed by the NL based response system 120 using one or more GMs, which could either be local to, or remote from, companion device 110. Additionally or alternatively, such identification could be based on pre-configured correlation data such as one or more databases. Additionally or alternatively, such identification could be based on user indication (e.g., either explicit user indication or data associated with the user’s profile) or some form of keyword matching. Other identification techniques could be used in other implementations.

Additionally or alternatively, the data representation used could be identified based on the data that results from processing of one or more sub-tasks. For example, the resultant data could more naturally fit with a pie chart than another type of visual data representation and/or some other type of textual or non-textual representation. For example, if the data is inherently numerical in nature showing relative percentages, then the system could automatically identify that a pie chart or some other similar visual data representation could be used to present or render that data.

Additionally or alternatively, the type of data representation could be based on an external factor such as an attribute of the user. Such information could be identified based on, for example, the user's profile or some other information related to the user. For example, if the user was visually impaired, then the system could identify based on the user's profile that a non-textual audio data representation could be a preferable way to render the data, rather than rendering through a textual data representation.

In some implementations, the subset of candidate data representations might be based on explicit feedback from the user. For example, consider a scenario where the data represents the breakdown of renewable energy sources in a particular region. The initial rendering might be a textual summary stating, "Solar energy accounts for 40%, wind energy 30%, and hydroelectric power 30% of the region's renewable energy mix." The user, however, might provide feedback indicating that a visual representation would be more helpful. In response, the system could generate a pie chart visually displaying the same data. If the user further indicates that they are interested in understanding the potential impact of policy changes on the energy mix, the system might generate an interactive simulation that allows the user to adjust various parameters (e.g., tax incentives for solar energy) and observe the resulting changes in the pie chart in real-time. If the user had a pre-existing preference for a non-textual audio data representation, then the system could render each source's contribution as a unique musical note or tone, with volume proportional to each source's contribution to the total energy mix. The user might then provide feedback that they prefer the pie chart due to their familiarity with that data representation.

In similar implementations, the system might explicitly provide different options related to the data representation. For example, in response to a research sub-task, the system might render to the user indications of one or more data representations with which to format an element such as textual, audio, and/or non-textual (e.g., as a graph, interactive element, etc.) data representations. The user could then select (or de-select) one or more of the different options either actively or passively (e.g., through expiration of a timer) for inclusion in the subset of data representations that are to be rendered based on the generated data. Based on the user's selection, one or more sub-tasks could be generated to generate and/or render the selected data representation, either using a GM or through a non-GM based process.

To illustrate, suppose a user wants to explore different ways to present market analysis data derived from an initial research sub-task. The initial sub-task might involve analyzing sales figures and consumer preferences for a particular product. A GM could then be used to identify potential data representations to render an element based on the resultant data, such as a textual summary highlighting key statistics, a bar graph visualizing sales trends over time, or an interactive map displaying regional market share. These options can be presented to the user via a user interface of an electronic device. If the user selects the bar graph and interactive map options, the same or different GMs could then generate new sub-tasks specifically tailored to create these visualizations. For instance, one sub-task could focus on generating a dataset suitable for a bar graph, while another could involve creating an interactive map with drill-down capabilities.

In some implementations, the prompt and/or the GM selected by the VLM selection engine 124 as previously discussed could be based on an intended output of the NL based response system 120. For example, a different prompt might be generated if the user requests (explicitly or implicitly) a specific type of data representation (e.g., a visual data representation) than if the user requested another type of output (e.g., an interactive data representation). As another example, the system could perform one or more research sub-tasks to generate data. Based on the generated data, the system could create a new research sub-task that generates a prompt that is processed by the same or a different NL based response system 120 using the same or a different GM. The generated prompt (and/or the GM used to process the prompt) in this scenario could be based on the data representation that is to be rendered to the user. As an example, a prompt that is related to generating an interactive data representation such as a quiz could be phrased as, “generate an interactive quiz having X features format based on the following data: [data] and VLM. [VLM1].” By contrast, a prompt that is related to generating a non-textual visual data representation such as a pie chart could be phrased as, “generate a pie chart, with a key, that reflects relevant parts of following data: [data] using VLM: [VLM2].” It will be understood that these non-limiting examples are highly simplified for the sake of discussion, and real-world implementations could use significantly more advanced prompts than are depicted herein.

To summarize the above-provided examples, various of these data representations could be identified based on the same underlying data. The identification of candidate elements having specific data representations can be based on various factors as described above, such as explicit user selection of desired representations from a presented list, implicit preferences derived from the user's profile (e.g., a preference for visual or audio data), the intended destination or section within the research report where the element will be rendered, the nature of the data generated by the research task (e.g., numerical data suggesting charts), characteristics of the research task itself, etc.

It will be understood that, in some implementations, the process can be recursive; for instance, an initial set of data representations could be identified. A first subset might then be generated based on where the element is to be rendered within the report. Indications of this subset could be presented to the user, who could then further refine the selection, leading to a final subset of elements to be generated with their respective data representations. Identifying the subset of candidate elements may be based on rendering one or more indications of the plurality of candidate elements, and identifying user input related to selection, de-selection, or an edit based on this rendering. This subset may be fewer candidate elements than the total number of candidate elements initially identified. Identifying the subset of candidate elements can also be based on identifying expiration of a timer that is related to the rendering of the one or more indications.

As has been noted, the above-described examples of the types of data representations, the factors that can be included in identifying a subset of possible data representations, etc. is intended as a generalized non-limiting example. Other factors, other types of data representations, other criteria for selection or de-selection, etc. can additionally or alternatively be present in other implementations.

In some implementations, as previously described, the candidate responses could additionally or alternatively be or include one or more new prompts. For example, if the system processes a research sub-task that generates data, then, rather than a new sub-task as previously described, a new prompt could be generated based that data. The prompt could relate to rendering the data, processing the data, etc. As another example, if the user changes one or more of the research sub-tasks or one or more resources after initial processing of the resource(s) or generation/processing of the sub-task(s), then the system could generate a new prompt based on one or more of those changes.

In some implementations, the candidate responses can additionally or alternatively be or include, for example, generation or identification of one or more sub-tasks related to the research task. For example, a user input could relate to a given research task such as “analyze a relationship between Corporate Entity X and Corporate Entity Y in the attached three documents.” The user could then provide three documents (Documents A, B, and C) for use as resources. Based on the user’s input and the content of the resources, the VLM response generation engine 128 could generate research sub-tasks such as “Analyze co-ownership interests between Entity X and Entity Y based on data from Document A,” “Analyze market overlap between Entity X and Entity Y based on Document B,” and so on.

In other words, the content of the resources themselves could be used to inform the sub-tasks that are generated based on the user’s input. These implementations could be beneficial because the research sub-tasks could be tailored to the available information, thereby increasing the relevance and usefulness of the provided sub-tasks. For example, the system could avoid using excess computing resources on generating and/or executing one or more sub-tasks that have inadequate information for such execution based on the provided resources.

It will be noted that, as discussed elsewhere herein, in some implementations the process of sub-task generation could be iterative. For example, subsequent to rendering of one or more of the sub-tasks to the user, the user could introduce a new resource, remove a previously-provided resource, and/or edit or otherwise alter one or more of the resources. Based on this change, the NL based response system 120 could generate one or more new sub-tasks based on the change to the resource(s).

In some implementations, the generated sub-task(s) could be generated based on one or more user-profile characteristics as previously described with respect to the prompt. For example, if the user speaks French, then one sub-task could be “translate one or more user-provided resources to French.” Similarly, if the user is an experienced electrical engineer, then an example sub-task could be “avoid discussion of basic concepts such as amperage, voltage, inductance, or resistance.”

In some implementations, the candidate responses can additionally or alternatively be or include, for example, identification of one or more resources that are to be used, or are not to be used, for the research task. For example, continuing with the above example related to Entities X and Y, the prompt generation by the VLM input engine 126 could take into account the user’s input of “in the attached three documents.” Based on this explicit user instruction, the VLM response generation engine 128 could generate a sub-task such as “exclude resources beyond the user-provided resources.” Conversely, if the user’s input was shortened to “analyze a relationship between Corporate Entity X and Corporate Entity Y,” then a generated sub-task could be “identify and present resources that relate to both Corporate Entity X and Corporate entity Y.”

It will be understood that the preceding descriptions are intended as non-limiting descriptions of possible responses or response types that can be generated for candidate responses, and other implementations can include one or more additional or alternative types or data.

The response selection engine 132 can then select one or more responses from, for example, the set of candidate responses output by the VLM response generation engine 128. The response selection engine 132 can, in some examples, select the candidate response with the highest confidence score for performance by the user device 110. In some examples, the response selection engine 132 can compare the confidence scores of the candidate responses to a threshold score. The threshold score could be pre-configured and/or identified based on a variety of the previously-described factors such as user profile, user input, context, etc. The selected response(s) can be selected from the set of candidate responses with a confidence score that exceeds the threshold score. If no candidate response has a confidence score that exceeds the threshold score, the response selection engine 132 can select a default response, e.g., a response that outputs a request for further information from the user (e.g., via the companion device 110).

The response generation engine 134 can convert the response selected by the response section engine 132 into one or more commands for an application that, when implemented by an application on the companion device, 110, or by one or more further applications 160 cause the application to perform the action that is related to the response. In some implementations as described herein, the action performed might be rendering (for example on a display of companion device 110 via rendering engine 112) one or more of the generated textual and/or non-textual elements of the research results based on the selected candidate response. In some implementations, the action performed might involve rendering one or more candidate resources that are to be used in the performance of the research task. In some implementations, the action performed might involve rendering one or more of the research sub-tasks that were identified or generated based on the prompt and/or the research task.

The NL based response system 120 can further include one or more storage devices 138. The one or more storage devices 138 can be similar to, and share one or more characteristics with, the one or more storage devices 116. In some implementations, for example implementations where the NL based response system 120 and the companion device 110 are implemented as a single physical unit (e.g., a smart phone or tablet or some other similar device), the one or more storage devices 116 and 138 can be the same storage device (e.g., a single storage device with no redundancy) or there can be two or more distinct storage devices or types of storage devices.

The one or more further applications 160 is illustrated as including one or more search engines 162, one or more tools 164, one or more third-party applications 164, one or more web browsers 166 and/or one or more login managers 170. Some of the applications can be omitted in various implementations. Further applications can also be included in the one or more further applications 160, such as one or more first party applications and/or other applications. The one or more further applications 160 can be executed on a virtual machine, e.g., in a secure virtual environment, such as in a secure environment in the cloud or locally on the companion device 110.

The one or more search engines 162 can receive a search request from the NL based response system 120 and/or companion device 110 and perform a search operation on a search space. The one or more search engines 162 can return one or more search results to the NL based response system 120 and/or the companion device 110. The one or more search engines 162 can include an internet search engine.

The one or more tools 164 can include, for example, applications that can be used to perform creative tasks, such as one or more image tools for creating and/or editing images, one or more document tools for reading, writing and/or editing documents, one or more audio tools for listening to, creating and/or editing audio. For example, in some implementations the one or more tools 164 could be used by one or more elements of the NL based response system 120 to generate a non-textual element as previously described. Many other examples are possible and are also contemplated herein.

The one or more third party applications 166 can include applications that are hosted and/or controlled by a third party for providing access to services that they provide. Examples of such third party applications include, but are not limited to: booking applications; e-commerce applications; translation applications; utility provider applications; calendar/diary applications; and/or the like.

The one or more web browsers 168 can be or refer to applications that provide access to internet webpages.

The one or more login managers 170 can securely store login credentials (e.g., login names, passwords, etc.) of a user for respective application and/or webpages. The login manager can automatically input relevant login details to an application when it is accessed and/or to a webpage when it is loaded. However, it should be noted that the NL based response system 120 can ensure that any login credentials are not included in any VLM input, but the response selection engine 132 and/or the response generation engine 134 can cause any needed login credentials to be utilized.

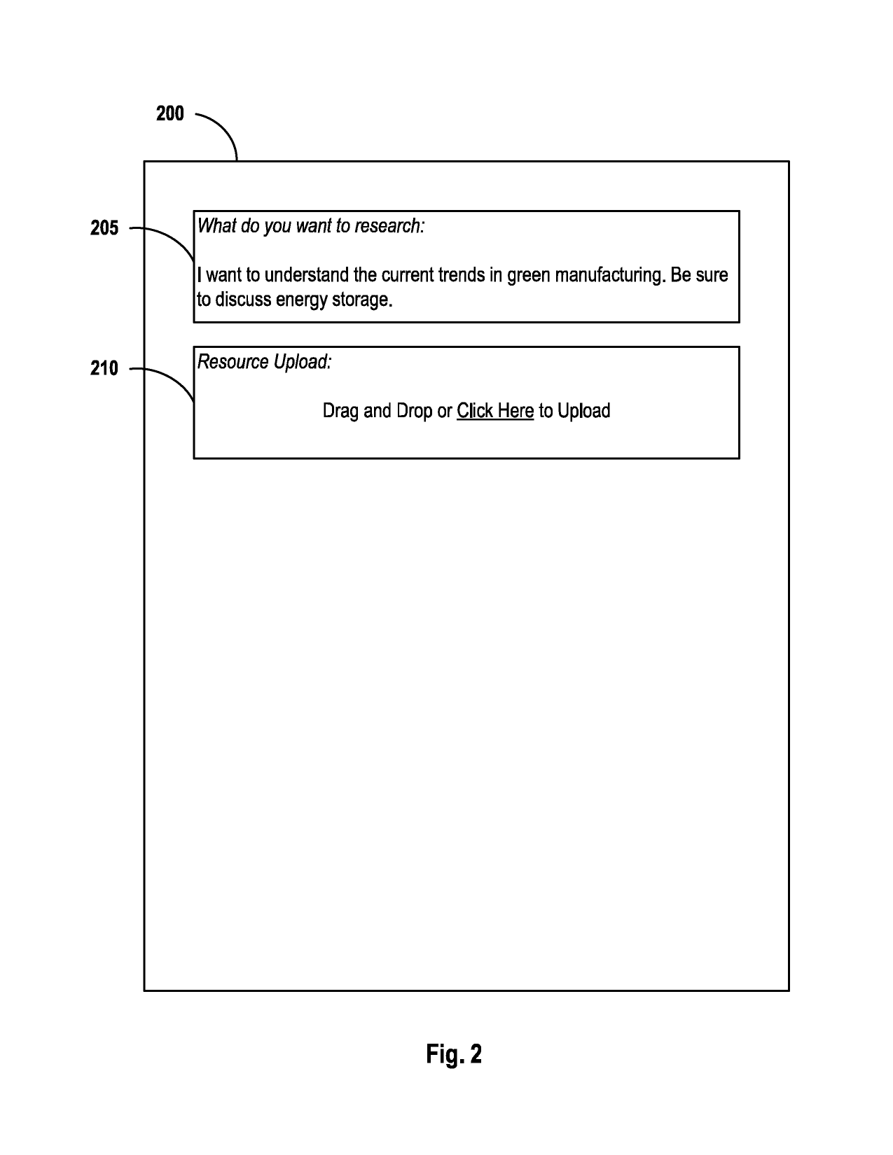

FIG. 2 depicts an example of a user interface 200 in accordance with various implementations herein. Implementations herein will be described in accordance with the example of a research task related to clean energy. However, it will be understood that this description is a non-limiting example for the sake of discussion, and implementations are not limited to a particular topic. Similarly, it will be understood that the depictions of the user interface 200 and/or various elements of the user interface 200 are intended as highly simplified non-limiting examples. The specific size, shape, orientation, numbers of elements, wording, etc. can differ in different implementations. For example, some elements can be combined, some elements can be separated into separate elements than depicted in one or more of the Figures herein, etc.

The example user interface 200 might include a user input portion 205 and a user-provided resource portion 210. In some implementations, the user can provide input to the system (e.g., a system such as that described with respect to FIG. 1) at the user input portion 205. In some implementations, the user-provided input can be, for example, written (e.g., typed) input, spoken input (such as might be translated via a speech-to-text engine), and/or some other type of input as previously described with respect to the user input engine 111. The user input can be, for example, related to a research task. In this example, the user has provided the following natural language input (e.g., using a physical or virtual keyboard): "I want to understand the current trends in green manufacturing. Be sure to discuss energy storage."

The user-provided resource portion 210 can be a portion of the user interface 200 where a user is able to upload one or more resources that are to be used by the system for the research task. For example, the user may be able to provide the resources as a document, as a portable document file (PDF), as an image file, as a video file, as an audio file, etc. The user might be able to provide the file by "clicking" or otherwise interacting with an element of the user the user-provided resource portion 210, by dragging and dropping an icon of the file, by providing a uniform resource locator (URL) associated with the file, etc.

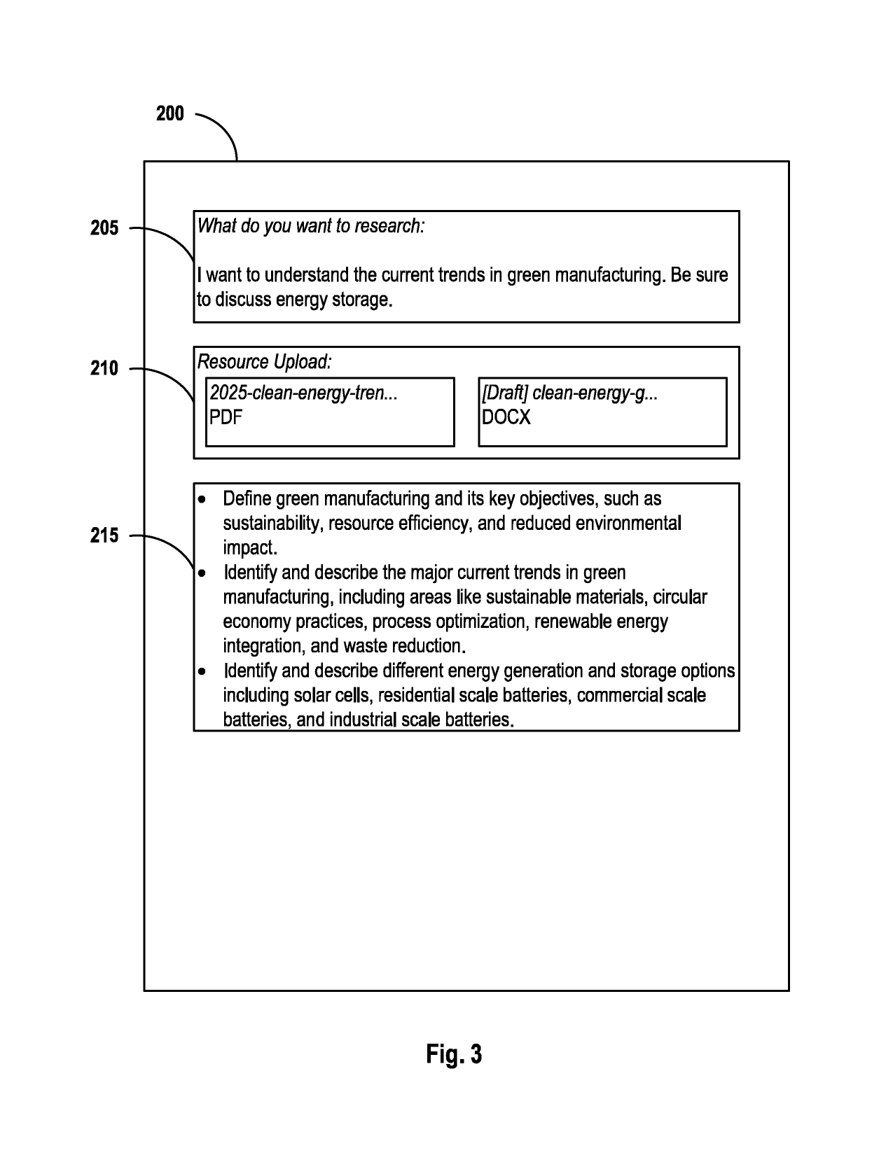

FIG. 3 depicts an example of an iteration of the user interface 200. As shown at 210, the user has provided a PDF file and a DOCX file at the user-provided resource portion 210. FIG. 3 further depicts a research sub-task portion 215. As can be seen in FIG. 3, the research sub-task portion 215 can depict a plurality of research sub-tasks. The research sub-tasks can be generated based on a prompt that is associated with the user input in the user input portion 205. For example, the user might provide an input to the user input portion 205 of the user interface 200 (e.g., via user input engine 111 and/or application(s) 115 of companion device 110) such as: "I want to understand the current trends in green manufacturing. Be sure to discuss energy storage."

Based on the user input and/or the one or more resources, the NL based response system 120 could use one or more of VLM(s) 150 to generate sub-tasks such as the depicted sub-tasks at 215: “Define green manufacturing and its key objectives, such as sustainability, resource efficiency, and reduced environmental impact,” “Identify and describe the major current trends in green manufacturing, including areas like sustainable materials, circular economy practices, process optimization, renewable energy integration, and waste reduction,” and “Identify and describe different energy generation and storage options including solar cells, residential scale batteries, commercial scale batteries, and industrial scale batteries.” Indications of one or more of the sub-tasks could then be provided to the user as shown in FIG. 3, for example using rendering engine 112 and/or output device(s) 114 of the companion device 110 as previously described.

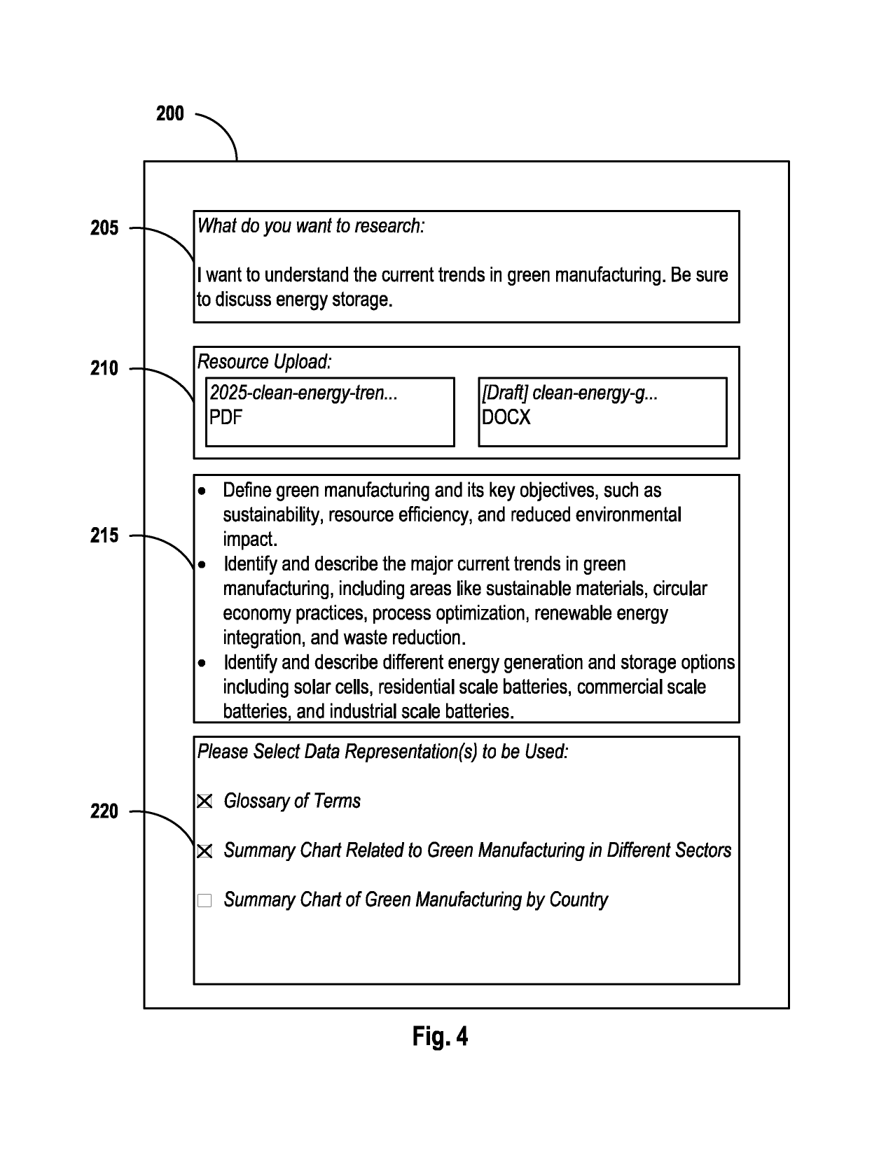

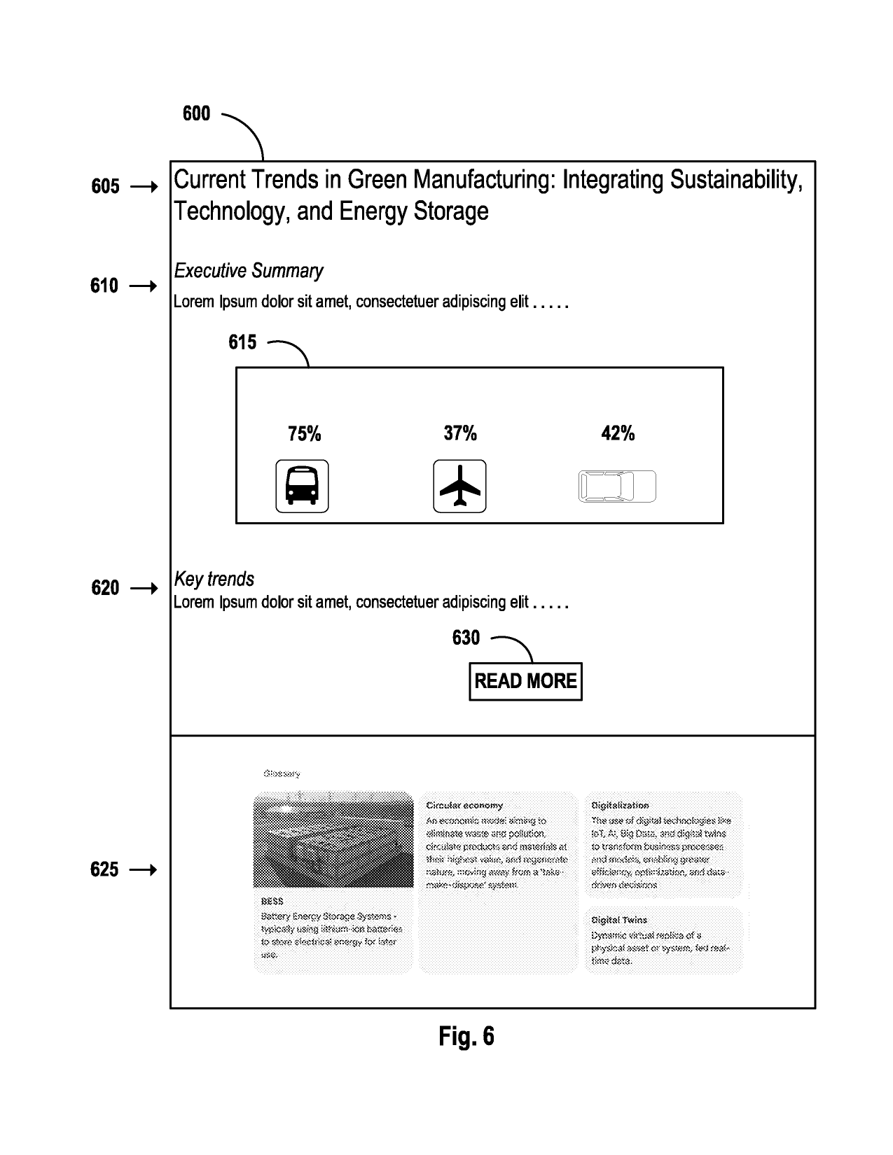

FIG. 4 depicts an example of a further iteration of the user interface 200. Specifically, as shown in FIG. 4, the system may provide one or more indications of one or more possible data representations to the user at 220. For example, as depicted in FIG. 4, the NL based response system 120 could identify different options for data representations to be included in a research report such as that depicted below in FIG. 6. The identification of these data representations could be based on various factors, which could include the research task and/or one or more of the research sub-tasks (e.g., one or more of the sub-tasks depicted at 215). For example, if a research sub-task involves defining terms, as shown at 215 ("Define green manufacturing and its key objectives..."), the system could identify a glossary data representation as a suitable data representation, as indicated in section 220 of FIG. 4. Similarly, if the research task or sub-tasks involve analyzing data related to sectors or countries, the system could identify summary chart data representations, as also shown in section 220 of FIG. 4 ("Summary Chart Related to Green Manufacturing in Different Sectors," "Summary Chart of Green Manufacturing by Country"). These identified data representation options could be rendered to a user via a user interface on a companion device 110, potentially through the rendering engine 112 and output device(s) 114. As previously described, the NL based response system 120, potentially using the VLM response generation engine 128 and VLM(s) 150, could identify these candidate elements and their data representation(s) based on the substance of the research tasks and potentially other factors, such as user attributes determined by a context engine 113, implicit or explicit user input provided via a user input engine 111, etc.

As shown in FIG. 4, the user could be allowed to select one or more of the candidate data representations at 220. For example, the user can actively select or passively allow the selection of one or more of the options displayed in section 220 of FIG. 4. An active selection could involve the user interacting with a user interface element, such as a checkbox or radio button associated with a specific data representation option (e.g., clicking the box next to "Glossary of Terms"). As depicted by the "X" in several boxes at 220, the user has actively selected the options for "Glossary of Terms" and "Summary Chart Related to Green Manufacturing in Different Sectors." In some implementations, selection of an element could direct the system to use that data representation in rendering data, as shown. In other implementations, selection of a data representation could direct the system to not use that particular data representation in rendering an element. A passive selection could occur if, for example, the system automatically selects default data representations upon the expiration of a timer without explicit user input, or if the user makes no selections and a pre-configured set of options is chosen. Regardless of whether the selection is active or passive, the system could identify the resulting subset of candidate elements based on this selection process.

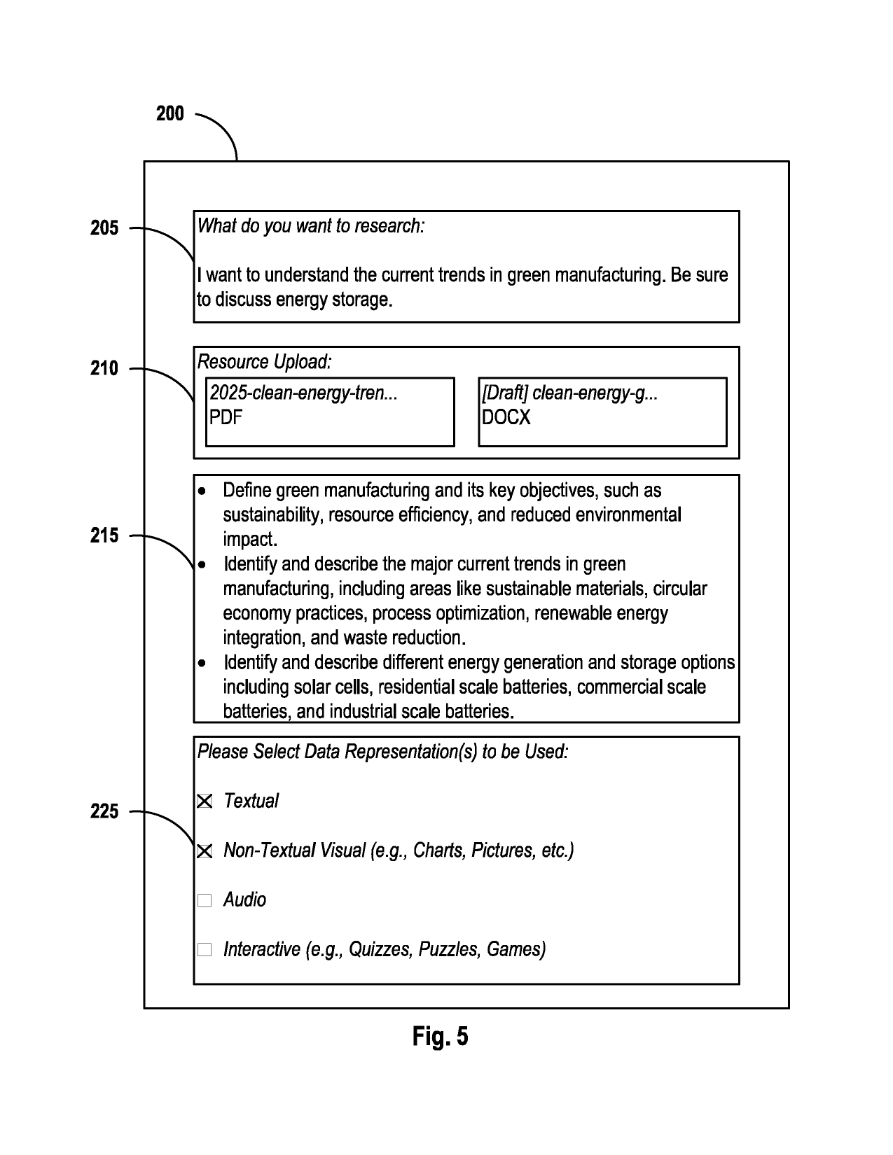

FIG. 5 depicts an alternative view of the user interface 200. Similarly to the user interface depicted at FIG. 4, the user interface 200 of FIG. 5 depicts a portion 225 in which different data representation options can be presented to the user as shown. However, in this implementation, rather than a detailed description of the resultant element (e.g., a "Glossary of Terms" or a "Summary Chart Related to . . "), the portion 225 depicts a more general description of the candidate types of data representations. A more general depiction could be preferred if, for example, the user has specific needs or preferences for the modality of the information presented. For instance, if the user were visually impaired, they might strongly prefer non-textual audio data representations over textual or visual ones. In this case, presenting options like "Textual" or "Non-Textual Visual" would allow the user to explicitly choose to avoid these modalities. Conversely, a teacher preparing a lesson for an elementary school classroom might prioritize "Interactive" data representations, such as quizzes or games, to engage young students, rather than specific element types like a glossary or chart. Offering the broader categories of data representation could allow the user to focus on the type of presentation that best suits their needs, rather than having to select from pre-defined specific elements that might not align with their required modality. This approach could empower users with diverse needs to tailor the output to their specific requirements for accessing and utilizing the research findings.

Based on one or more of the research task identified based on the user input at 205, the user-provided resources at 210, the one or more generated research sub-tasks at 215, and/or the selected data representation, the system of FIG. 1 can perform one or more of the identified research task and/or one or more of the research sub-tasks to generate research results as shown in FIG. 6.

As an example, FIG. 6 depicts an example of a research report 600 that can be generated based on the generated research results. As previously described, VLM input could be generated by the VLM input engine 124 using various of the above-described elements such as those of FIGS. 2-5. Using this VLM input, the NL based response system 120 could use one or more of the VLMs 150 to generate one or more responses (e.g., research results) based on the research task and/or research sub-task(s). As previously described, generation of the one or more responses could include generation of a variety of elements with textual and/or non-textual data representations that could subsequently be provided to the user via the user interface 200 and/or rendering engine 112 of the companion device 110.

In this specific example, FIG. 6 presents different data representations of information related to current trends in green manufacturing within a research report 600. As previously noted, the data representations shown can be based on results generated from performing a research task or one or more research sub-tasks. Specifically, section 610 provides an "Executive Summary" utilizing a textual data representation. This representation presents a high-level overview of the topic using written language, indicated by the placeholder text. Section 615 depicts a placeholder visualization resembling a bar chart, which exemplifies a non-textual visual data representation. While the data is not explicitly shown in this placeholder, such a representation can convey quantitative or comparative data derived from the research results in a graphical format. Section 625 illustrates a "Glossary" section, which uses a textual data representation formatted as definitions for specific terms related to the research topic, such as "Battery Energy Storage Systems (BESS)," "Circular economy," "Digitalization," and "Digital Twins." This presentation allows for the clear and concise definition of key terminology. Section 620 presents a "Key trends" section, also employing a textual data representation to describe significant developments or patterns identified through the research, again indicated by placeholder text. Section 630 includes a "READ MORE" link, which, while presented textually, could potentially lead to an interactive data representation or a different data representation not explicitly depicted, allowing a user to explore the information further. These different data representations allow a user to interact with and understand the same underlying research results in various formats tailored to different needs and preferences.

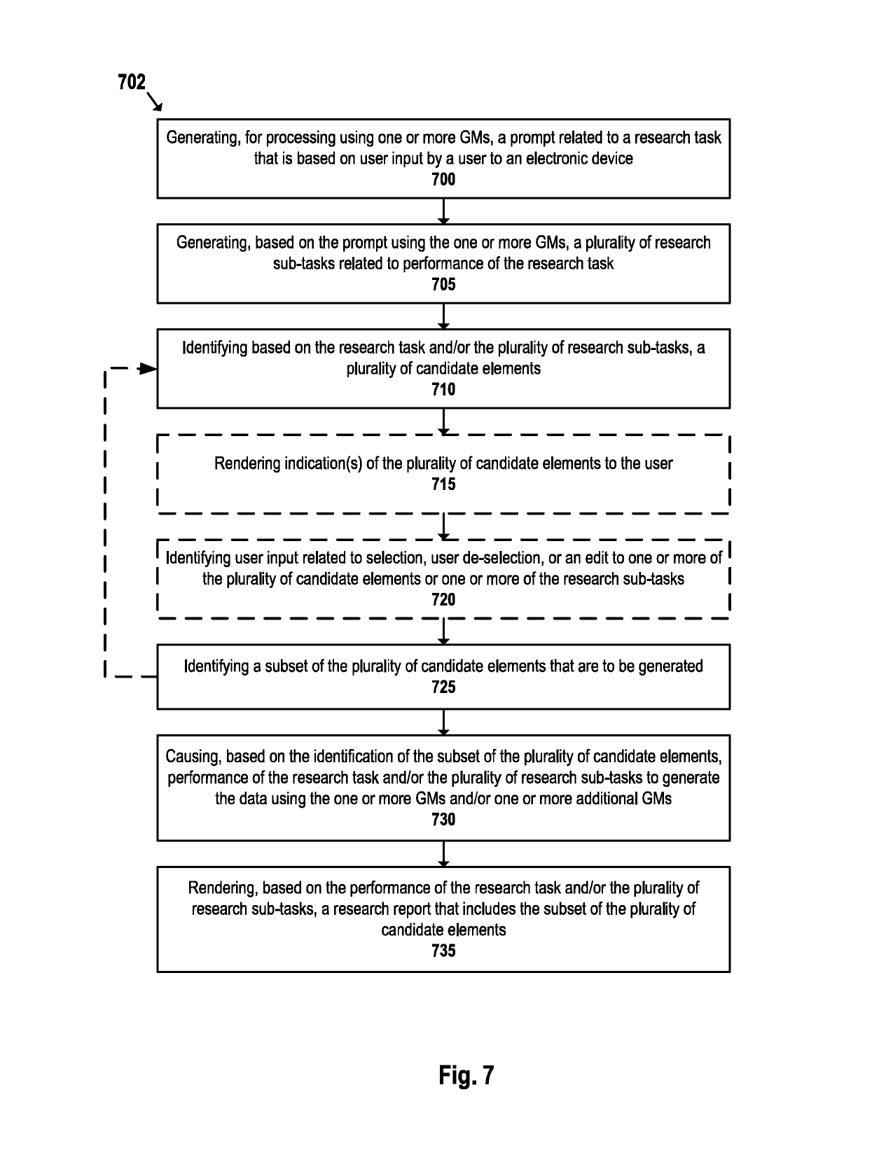

FIG. 7 depicts a flowchart of a process 702 for generating a research report.

At block 700, the process 702 can include generating, for processing using one or more generative models (GMs), a prompt related to a research task that is based on user input by a user to an electronic device. For example, the user input could be provided via the user input engine 111 of the companion device 110, and the prompt generated by the VLM input engine 126 of the NL based response system 120 as described in FIG. 1.

At block 705, the process 702 can include generating, based on the prompt using the one or more GMs, a plurality of research sub-tasks related to performance of the research task. As described in FIG. 3, the research sub-tasks can be displayed in a research sub-task portion 215 of a user interface 200.

At block 710, the process 702 can include identifying, based on the research task and/or the plurality of research sub-tasks, a plurality of candidate elements for inclusion in a research report that is rendered to the user based on a result of performance of one or more of the research task and/or the plurality of research sub-tasks, wherein respective ones of the plurality of candidate elements are to be based on a same data of the result and have a different data representation from one another. As shown in FIG. 4, a section 220 of the user interface 200 can present examples of candidate elements with different data representations such as a Glossary of Terms or a Summary Chart. Some candidate elements can include a textual data representation, a non-textual visual data representation, a non-textual audio data representation, or an interactive data representation. The data representation of a candidate element may be identified based on an attribute of the user or a characteristic of the research task itself. Additionally or alternatively, as shown in FIG. 5, a section 225 of the user interface 200 can present examples of types of candidate elements.

At block 715, the process 702 can optionally (as indicated by the dashed line surrounding the element) include rendering indication(s) of the plurality of candidate elements (and/or element types) to the user. As depicted in FIG. 4 and FIG. 5, indications of candidate elements and their data representations can be presented in sections 220 and 225 of the user interface 200, potentially using the rendering engine 112 and output device(s) 114 of the companion device 110 as described in FIG. 1.

At block 720, the process 702 can optionally (as indicated by the dashed line surrounding the element) include identifying user input related to selection, user de-selection, or an edit to one or more of the plurality of candidate elements or one or more of the research sub-tasks. User input can be identified via the user input engine 111 of the companion device 110. This input could include selecting or deselecting options presented in the user interface as shown in FIG. 4 and FIG. 5. Identifying user input may be based on the rendering of the one or more indications of the plurality of candidate elements. Identifying user input related to a change to a candidate element, such as requesting a different type of chart or level of detail, can also be included, which could result int he process returning to element 710 as shown by the dashed line. Additionally, user input related to changes to the research sub-tasks, such as editing a sub-task description or adding resources, could also be identified.

At block 725, the process 702 can include identifying a subset of the plurality of candidate elements that are to be generated. As previously discussed, this identification can be based on explicit user selection and/or de-selection of options presented in sections 220 and 225 of the user interface 200, potentially following the optional rendering at block 715 and identification of user input at block 720. The identification of the subset can also be based on the expiration of a timer related to the rendering of the indications of the plurality of candidate elements, where a default subset is automatically identified if no user input is received within a predefined time.

Additionally or alternatively, the identification of the subset can be based on criteria that do not require the optional rendering of the indications of candidate elements at 715 and 720. For example, the identification of the subset can be based on the type of data that is to be rendered (e.g., numerical data could lead to the prioritization of visual representations like charts), where the element is to be rendered within the research report (e.g., a summary section might favor textual representations, while a data appendix might favor tables), an attribute of the user (e.g., user profile indicating a preference for audio or visual data), or initial user instructions provided as part of the user input at block 700 or in separate configuration settings. Identifying the subset of candidate elements may result in selecting fewer candidate elements than the total number initially identified at block 710.

In some implementations, as previously noted, the identification of the subset could optionally be an iterative process, as indicated by the dashed line at 710. For example, an initial set of data representations could be identified, such as textual summaries, detailed tables, and graphical representations. A first subset of these could be identified based on a user's expressed preference for visual data, leading to the selection of graphical representations. Indications of this first subset could be presented to the user. Based on the user's feedback, which might include selecting specific types of graphs (e.g., a line graph and a bar chart) from the initially presented graphical options, a second subset (which is a subset of the first subset) could be identified, comprising only the line graph and the bar chart. The system would then proceed to generate only these two graphical representations, ensuring that resources are focused on the user's refined preferences.

At block 730, the process 702 can include causing, based on the identification of the subset of the plurality of candidate elements, performance of the research task and/or the plurality of research sub-tasks to generate the data using the one or more GMs and/or one or more additional GMs. This can involve the VLM response generation engine 128 of the NL based response system 120 using VLM(s) 150 or other GMs to perform the research and generate the data.

In some implementations, based on the data generated by performing one or more research sub-tasks, a data representation of a candidate element that had not previously been considered could be identified. For example, the system could be configured to identify that the resultant data can cause the identification of a new data representation, which can cause the process 702 to re-iterate back to element 710. For example, if the data generated by the research task is complex or multi-faceted, the system might identify a need to present this data in additional formats beyond those initially considered or selected. This identification could trigger a return to block 710 to identify a new set of candidate elements with different data representations that might be better suited to conveying the nuances of the generated data. This could involve identifying entirely new types of data representations (e.g., an interactive simulation if the data relates to dynamic systems) or refining the options within previously selected types (e.g., identifying specific types of charts based on the structure of the numerical data).

At block 735, the process 702 can include rendering, based on the performance of the research task and/or the plurality of research sub-tasks, a research report that includes the subset of the plurality of candidate elements. As shown in FIG. 6, the research report 600 can include various sections with different data representations, such as an Executive Summary 610 with textual data representation, a visual representation 615, a Key Trends section 620 with textual data representation, and a Glossary 625 with textual data representation. An additional candidate element with a data representation different from those in the subset may also be identified based on the generated data and included in the research report. This rendered research report, including the selected subset of candidate elements and potentially additional elements, can be presented to the user via the user interface 200 and/or rendering engine 112 of the companion device 110. In some implementations, based on the data, a candidate element of the subset can be generated using the one or more GMs. This generated candidate element may also be based on a portion of the research report that is to be rendered.

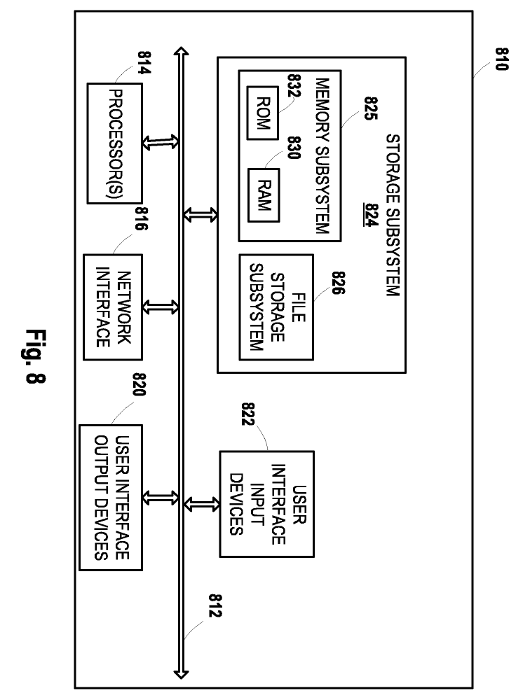

FIG. 8 is a block diagram of an example computer system 810. Computer system 810 typically includes processor(s) 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computer system 810. Network interface subsystem 816 provides an interface to outside networks and is coupled to corresponding interface devices in other computer systems.

In various implementations, computer system 810 could be or implement one or more of the companion device 110, the NL based response system 120, the application(s) 160, etc. In some implementations, the storage subsystem 824 could store one or more of VLMs 150, or implement one or both of storage devices 116/138.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, user interface input devices 822 may include any device for inputting information into computer system 810.

User interface output devices 820 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, user interface output devices 820 may include any device for outputting information from computer system 810 to the user or to another machine or computer system.

Storage subsystem 824 stores programming and data constructs that provide the functionality of some or all of the modules described herein. For example, the storage subsystem 824 may include the logic to perform selected aspects of the method of FIG. 7. These software modules are generally executed by processor(s) 814 alone or in combination with other processors. Processor(s) 814 may take various forms, such as a central processing unit (CPU), a graphics processing unit (GPU), a tensor processing unit (TPU), a neural processing unit (NPU), and so forth.

Memory 825 used in the storage subsystem 824 can include a number of memories including a main random access memory (RAM) 830 for storage of instructions and data during program execution and a read only memory (ROM) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computer system 810 communicate with each other as intended. Although bus subsystem 812 is shown schematically as a single bus, alternative implementations of the bus subsystem may use multiple busses.

Computer system 810 can be of varying types including a workstation, server, computing cluster, blade server, server farm, or any other data processing system or computing device. Due to the ever-changing nature of computers and networks, the description of computer system 810 depicted in FIG. 8 is intended only as a specific example for purposes of illustrating some implementations. Many other configurations of computer system 810 are possible having more or fewer components than the computer system depicted in FIG. 8.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used. Moreover, features described herein may be activated, deactivated, and reactivated at the individual’s discretion.

In various implementations, a computer-implemented method may include generating a prompt related to a research task that is based on user input received by an electronic device. This prompt may be generated for processing using one or more generative models (GMs). Based on the prompt, a plurality of research sub-tasks related to performance of the research task may be generated using the one or more GMs. Based on the research task and/or the plurality of research sub-tasks, a plurality of candidate elements may be identified for inclusion in a research report that is rendered to the user. The research report may be based on a result of performance of one or more of the research task and/or the plurality of research sub-tasks. Respective ones of the plurality of candidate elements may be based on the same data of the result and may have a different data representation from one another. A subset of the plurality of candidate elements that are to be generated may be identified. Based on the identification of the subset of the plurality of candidate elements, performance of the research task and/or the plurality of research sub-tasks may be caused to generate the data using the one or more GMs and/or one or more additional GMs. Based on the performance of the research task and/or the plurality of research sub-tasks, a research report that includes the subset of the plurality of candidate elements may be rendered.

In various implementations, a candidate element of the subset of the plurality of candidate elements may be generated based on the data of the result using the one or more GMs.

In various implementations, the candidate element generated based on the data of the result may also be based on a portion of the research report that is to be rendered.

In various implementations, based on the generation of the data, an additional candidate element that has a data representation that is different from data representations of respective ones of the subset of the plurality of candidate elements may be identified. The research report may then be rendered to include the subset of the plurality of candidate elements and the additional candidate element.

In various implementations, the subset of the plurality of candidate elements may include fewer candidate elements than all of the plurality of candidate elements initially identified.

In various implementations, identifying the subset of the plurality of candidate elements may be based on rendering one or more indications of the plurality of candidate elements.

In various implementations, identifying the subset of the plurality of candidate elements may be based on identifying a user selection of at least one candidate element of the subset of the plurality of candidate elements, based on the rendering of the one or more indications of the plurality of candidate elements.

In various implementations, identifying the subset of the plurality of candidate elements may be based on identifying a user de-selection of at least one candidate element that is not in the subset of the plurality of candidate elements, based on the rendering of the one or more indications of the plurality of candidate elements.

In various implementations, identifying the subset of the plurality of candidate elements may be based on identifying expiration of a timer that is related to the rendering of the one or more indications of the plurality of candidate elements.

In various implementations, identifying the subset of the plurality of candidate elements may include identifying user input related to a change to a candidate element of the one or more candidate elements, based on the rendering of the one or more indications of the plurality of candidate elements.

In various implementations, identifying the subset of the plurality of candidate elements may further include rendering one or more indications of the one or more research sub-tasks, identifying user input related to one or more of the research sub-tasks based on the rendering of the one or more indications of the one or more research sub-tasks, and identifying a candidate element of the subset of candidate elements based on the user input related to the one or more research sub-tasks.

In various implementations, a candidate element of the plurality of candidate elements may include a textual data representation.

In various implementations, a candidate element of the plurality of candidate elements may include a non-textual visual data representation.

In various implementations, a candidate element of the plurality of candidate elements may include a non-textual audio data representation.

In various implementations, a candidate element of the plurality of candidate elements may include an interactive data representation.

In various implementations, a data representation of a candidate element of the plurality of candidate elements may be identified based on an attribute of the user.

In various implementations, a data representation of a candidate element of the plurality of candidate elements may be identified based on a characteristic of the research task.

Other implementations may include a transitory or non-transitory computer readable storage medium storing instructions executable by a processor to perform a method such as one or more of the methods described above. Yet another implementation may include a system including memory and one or more processors operable to execute instructions, stored in the memory, to implement one or more modules or engines that, alone or collectively, perform a method such as one or more of the methods described above.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A computer-implemented method comprising:
generating, for processing using one or more generative models (GMs), a prompt related to a research task that is based on user input by a user to an electronic device;
generating, based on the prompt using the one or more GMs, a plurality of research sub-tasks related to performance of the research task;
identifying, based on the research task and/or the plurality of research sub-tasks, a plurality of candidate elements for inclusion in a research report that is rendered to the user based on a result of performance of one or more of the research task and/or the plurality of research sub-tasks, wherein respective ones of the plurality of candidate elements are to be based on a same data of the result and have a different data representation from one another;
identifying a subset of the plurality of candidate elements that are to be generated;
causing, based on the identification of the subset of the plurality of candidate elements, performance of the research task and/or the plurality of research sub-tasks to generate the data using the one or more GMs and/or one or more additional GMs; and
rendering, based on the performance of the research task and/or the plurality of research sub-tasks, a research report that includes the subset of the plurality of candidate elements.

2. The computer-implemented method of claim 1, further comprising generating, based on the data of the result using the one or more GMs, a candidate element of the subset of the plurality of candidate elements.

3. The computer-implemented method of claim 2, wherein the candidate element is further based on a portion of the research report that is to be rendered.

4. The computer-implemented method of claim 1, further comprising:
identifying, based on the generation of the data, an additional candidate element that has a data representation that is different from data representations of respective ones of the subset of the plurality of candidate elements; and
rendering the research report that includes the subset of the plurality of candidate elements and the additional candidate element.

5. The computer-implemented method of claim 1, wherein the subset of the plurality of candidate elements is fewer candidate elements than all of the plurality of candidate elements.

6. The computer-implemented method of claim 1, wherein identifying the subset of the plurality of candidate elements is based on rendering one or more indications of the plurality of candidate elements.

7. The computer-implemented method of claim 6, wherein identifying the subset of the plurality of candidate elements is based on identifying, based on the rendering of the one or more indications of the plurality of candidate elements, a user selection of at least one candidate element of the subset of the plurality of candidate elements.

8. The computer-implemented method of claim 6, wherein identifying the subset of the plurality of candidate elements is based on identifying, based on the rendering of the one or more indications of the plurality of candidate elements, a user de-selection of at least one candidate element that is not in the subset of the plurality of candidate elements.

9. The computer-implemented method of claim 6, wherein identifying the subset of the plurality of candidate elements is based on identifying expiration of a timer that is related to the rendering of the one or more indications of the plurality of candidate elements.

10. The computer-implemented method of claim 6, wherein identifying the subset of the plurality of candidate elements includes identifying, based on the rendering of the one or more indications of the plurality of candidate elements, user input related to a change to a candidate element of the one or more candidate elements.

11. The computer-implemented method of claim 6, wherein identifying the subset of the plurality of candidate elements further includes:
rendering one or more indications of the one or more research sub-tasks;
identifying, based on the rendering of the one or more indications of the one or more research sub-tasks, user input related to one or more of the research sub-tasks; and
identifying a candidate element of the subset of candidate elements based on the user input related to the one or more research sub-tasks.

12. The computer-implemented method of claim 1, wherein a candidate element of the plurality of candidate elements includes a textual data representation.

13. The computer-implemented method of claim 1, wherein a candidate element of the plurality of candidate elements includes a non-textual visual data representation.

14. The computer-implemented method of claim 1, wherein a candidate element of the plurality of candidate elements includes a non-textual audio data representation.

15. The computer-implemented method of claim 1, wherein a candidate element of the plurality of candidate elements includes an interactive data representation.

16. The computer-implemented method of claim 1, wherein a data representation of a candidate element of the plurality of candidate elements is identified based on an attribute of the user.

17. The computer-implemented method of claim 1, wherein a data representation of a candidate element of the plurality of candidate elements is identified based on a characteristic of the research task.

18. One or more non-transitory computer-readable media comprising instructions that, upon execution of the one or more instructions by one or more processors of one or more electronic devices, are to cause the one or more electronic devices to:
generate, for processing using one or more generative models (GMs), a prompt related to a research task that is based on user input by a user to an electronic device;
generate, based on the prompt using the one or more GMs, a plurality of research sub-tasks related to performance of the research task;
identify, based on the research task and/or the plurality of research sub-tasks, a plurality of candidate elements for inclusion in a research report that is rendered to the user based on a result of performance of one or more of the research task and/or the plurality of research sub-tasks, wherein respective ones of the plurality of candidate elements are to be based on a same data of the result and have a different data representation from one another;
identify a subset of the plurality of candidate elements that are to be generated;
cause, based on the identification of the subset of the plurality of candidate elements, performance of the research task and/or the plurality of research sub-tasks to generate the data using the one or more GMs and/or one or more additional GMs; and
render, based on the performance of the research task and/or the plurality of research sub-tasks, a research report that includes the subset of the plurality of candidate elements.

19. An electronic device comprising:
one or more processors; and
one or more non-transitory computer-readable media comprising instructions that, upon execution of the one or more instructions by the one or more processors, are to cause the electronic device to:
generate, for processing using one or more generative models (GMs), a prompt related to a research task that is based on user input by a user to an electronic device;
generate, based on the prompt using the one or more GMs, a plurality of research sub-tasks related to performance of the research task;
identify, based on the research task and/or the plurality of research sub-tasks, a plurality of candidate elements for inclusion in a research report that is rendered to the user based on a result of performance of one or more of the research task and/or the plurality of research sub-tasks, wherein respective ones of the plurality of candidate elements are to be based on a same data of the result and have a different data representation from one another;
identify a subset of the plurality of candidate elements that are to be generated;
cause, based on the identification of the subset of the plurality of candidate elements, performance of the research task and/or the plurality of research sub-tasks to generate the data using the one or more GMs and/or one or more additional GMs; and
render, based on the performance of the research task and/or the plurality of research sub-tasks, a research report that includes the subset of the plurality of candidate elements.

20. The system of claim 19, wherein the subset of the plurality of candidate elements is fewer candidate elements than all of the plurality of candidate elements.
